(19) United States
(12) Patent Application Publication
(10) Pub. No.: US 2009/0216615 A1
(43) Pub. Date: Aug. 27, 2009

(54) Availability Check for a Ware

(75) Inventors: Andreas Poth, Weingarten (DE); Jochen Steinbach, Bad Schoenborn (DE)

Correspondence Address: FISH & RICHARDSON, P.C., PO BOX 1022, MINNEAPOLIS, MN, 55440-1022, US

(73) Assignee: SAP AG

(21) Appl. No.: 12/037,612

(22) Filed: Feb. 26, 2008

(51) Int. Cl. G06Q 10/00

(52) U.S. Cl. 705/10

(57) ABSTRACT

Computer-implemented methods, and associated computer program products and systems, for checking availability of a set of wares in a time interval, each ware having associated therewith at least one resource to produce the ware. In one aspect, the computer-implemented method includes determining at least first and second wares associated with the specific resource. The method further includes obtaining availability information for each of the determined first and second wares. The availability information comprises combined information comprising, for each date of the time interval, a combination of a supply quantity of the ware and a free capacity quantity of the specific resource. The free capacity quantity can be assigned to any of the determined first and second wares. In response to demand information representing a demand for a specific ware, the method includes determining the availability of the specific ware for the specific resource using at least the combined information.

### TECHNICAL FIELD

This document relates to computing systems and methods executed therein to perform availability check of a ware.

### BACKGROUND

A supply chain management computing system may be used to plan, implement and control the operations of a supply chain as efficiently as possible and may span all movement and storage of raw materials, inventory, and finished products.

Availability check, also known as ATP (availability-to-promise) check, is an important tool within supply chain management in order to provide an answer to the question if a requested quantity of a ware, for example a material or product, is available on a requested date. For determining if a ware is available, or if an overconfirmation is present otherwise, stock, planned inward movements and planned outward movements, like for example sales orders, may be considered. In the case of customer demand, a sales order is a customer request to the company for the delivery of wares, for example goods or services, at a certain time.

In make-to-stock environments, confirmations can usually be made based on product availability due to sufficient supply on stock. However, when dealing with make-to-order environments, there is often only little or no supply on stock. When a demand, or also referred to as requirement, is received, the availability check may have to be not mainly based on checking product availability (product availability check (PAC)), but on checking capacity availability (capacity availability check (CAC)) of one or more resources needed to produce the ware. In cases where there is no stock at all present, the availability check may merely be based on checking the capacity availability.

In an example manufacturing supply chain management computing system, the system may include capacity availability check suitable for checking the availability of a ware, the ware having a resource to produce the ware. In a typical case, when a customer demand, like a sales order, is received, a planned production order is created and is directly associated with the demand (lot-to-lot environment). The production order may then be included into a production plan using finite scheduling and by doing so checking the availability and capacity of the resources needed. Each time a demand is received, the production plan is changed.

In an example manufacturing supply chain management computing system, the system may first perform a ware availability check. Only in a case where the whole amount of the demand cannot be confirmed based on ware availability, a capacity availability check suitable for checking the availability of the ware may be used subsequently. This requires that a decision is made whether or not the whole amount of the demand can be confirmed only based on ware availability.

### SUMMARY

Computer-implemented methods, and associated computer program products and systems, are disclosed for checking availability of a set of wares in a time interval, each ware having associated therewith at least one resource to produce the ware.

In one aspect, the computer-implemented method includes determining at least first and second wares associated with the specific resource. The method further includes obtaining availability information for each of the determined first and second wares. The availability information comprises combined information comprising, for each date of the time interval, a combination of a supply quantity of the ware and a free capacity quantity of the specific resource. The free capacity quantity can be assigned to any of the determined first and second wares. In response to receiving a demand information representing a demand for a specific ware, the method includes determining the availability of the specific ware for the specific resource using at least the combined information.

In various implementations, the methods may include one or more of the following features. The supply quantity and the free capacity quantity may each be cumulated starting from a first date of the time interval. Furthermore, the supply quantity of the ware may be expressed in terms of a capacity quantity needed to produce the supply quantity using the specific resource. Regarding the combined information, the combination may include a sum of the supply quantity of the ware and the free capacity quantity of the specific resource. The availability information may further comprise blocked capacity information indicating for each date of the time interval a blocked capacity quantity of the specific resource. The blocked capacity quantity may be assigned to a corresponding one of the first and second wares. Further, a production order may be associated with each blocked capacity quantity, which is assigned to the corresponding ware. The supply quantity of the corresponding ware may comprise a stock of the corresponding ware and production orders associated with the corresponding ware. The free capacity quantity may be derived from a capacity capability of the specific resource and a blocked capacity quantity of the resource that is assigned to another ware other than the corresponding ware. The availability information may further comprise ware demand information comprising, for each date of the time interval, a demand quantity of the ware. The demand quantity may be compared to at least the combined information when determining the availability of the specific ware. After determining the availability of the specific ware for the specific resource, provided that the demand quantity is equal or smaller than the supply quantity, the combined information of the specific ware may be updated. Similarly, after determining the availability of the specific ware for the specific resource, provided that the demand quantity is greater than the supply quantity, the combined information of all wares associated with the resource may be updated. Finally, the specific resource may be a bottleneck resource.

In another aspect, a computer program product is disclosed. The computer program product is tangibly embodied in a computer-readable storage medium and includes instructions that, when executed, perform operations for checking availability of a set of wares in a time interval, each ware having associated therewith at least one resource to produce the ware, as described in connection with the methods described above. In yet another aspect, systems are disclosed that are capable of checking availability of a set of wares in a time interval, each ware having associated therewith at least one resource to produce the ware, as described in connection with the methods described above.

Implementations can provide any, all or none of the following advantages. When a ware demand is received, the availability of a specific ware for a specific resource may be determined using at least the combined information. Availability may therefore be determined based on supply of the ware and based on capacity of the resource associated with that ware. By using both information simultaneously, an optimal confirmation may be issued. It allows for the fact that flexible resources can also be used to produce and procure the product.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram of an exemplary system in which a supply chain management computing system is used.

FIG. 2 shows an exemplary capacity supply and capacity demand information.

FIG. 3 is a diagram showing an exemplary production of two wares, each using two resources.

FIG. 4 is a flowchart showing a computer-implemented method for checking the availability of a ware in a time interval which may be used in connection with a computer-implemented method for checking availability of a set of wares in a time interval.

FIG. 4A-4D are flowcharts with further details of an example method used in the method of FIG. 4.

FIG. 5A-5E are diagrams showing an example execution of a computer-implemented method for checking the availability of a ware in a time interval which may be used in connection with a computer-implemented method for checking availability of a set of wares in a time interval.

FIG. 6A-6D are tables used for an example computer-implemented method for checking availability of a set of wares in a time interval, each ware having associated therewith at least one resource to produce the ware.

FIG. 7A-7D are diagrams corresponding to the example method of FIG. 6A-6D.

FIG. 8 is a block diagram of a computing system that can be used in connection with the data structures and computer-implemented methods described in this document.

Like reference symbols in the various drawings indicate like elements.

### DETAILED DESCRIPTION

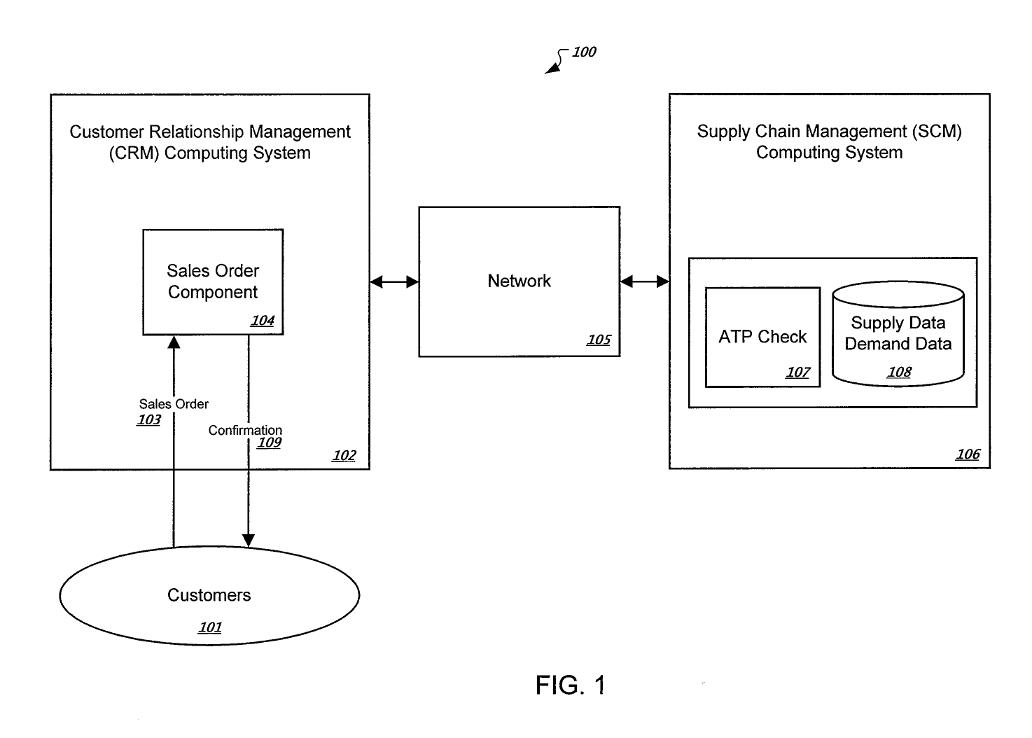

FIG. 1 is a block diagram of an exemplary system 100 in which a supply chain management (SCM) computing system 106 is used. Customers 101 may place sales orders 103, forming a demand requesting a ware in this example. The sales orders are sent to a sales order component 104 within a customer relationship (CRM) computing system 102. The sales order data, also referred to as demand data, may be sent via a network 105 or any other suitable means to supply chain management system 106. An ATP (Availability-to-promise) check component 107, also referred to as availability check component, may be part of supply chain management computing system 106.

Even though the demands referred to in FIG. 1 are sales orders placed by customers, availability check may also be used for other kinds of demands. For example for internal processes within a company the demands may be production (manufacturing) orders, purchase orders or planned orders. Also, while this and other examples herein refer to products being supplied and/or demanded, other wares than products can be considered as well. In other implementations, wares such as services can be supplied and/or demanded, for example in a computer system that schedules availability of consultants or other professionals.

ATP check component 107 may be placed within any suitable platform or system. In one implementation, the ATP check component may be placed within an Enterprise Resource Planning (ERP) System, for example the R/3 system by SAP AG Walldorf, Germany. In another implementation, the ATP check component may be placed within an Advanced Planning and Information (APO) system, for example the APO system by SAP AG, Walldorf, Germany. In yet another implementation, the ATP check may be placed within a system for small and medium sized businesses, like for example a Business By Design system by SAP AG, Walldorf, Germany.

ATP check component 107 may be able to access supply and demand data 108 and perform a availability check for a demand having a requested date. When there are multiple demands for a ware, it might be the case that more demand is confirmed on a certain date than supply is available on that specific date. In such a case, an overconfirmation is present on that date. Overconfirmations may for example occur when a change is made in the supply and demand data, for example when a requested date or quantity of a demand is changed or when a supply delivery changes. Demands that had a confirmed date and quantity up to that point of time, might no longer be confirmed after a change in the supply and demand data has occurred.

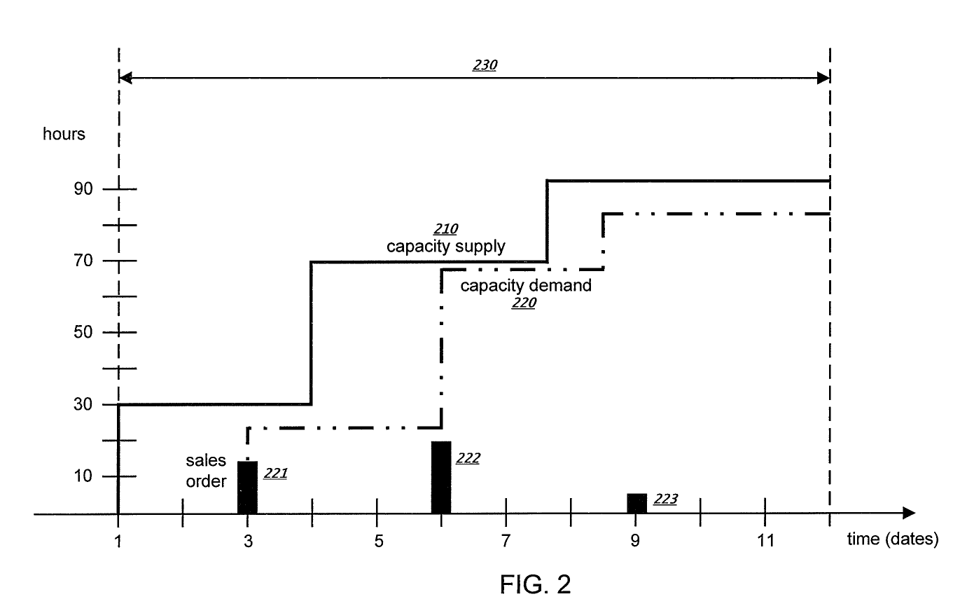

Referring to FIG. 2, an exemplary capacity supply and capacity demand information is shown. A cumulated capacity supply 210 and a cumulated capacity demand 220, also referred to as capacity supply and capacity demand time series, are plotted over a certain time interval 230. Cumulated here indicates that all supplies, and demands respectively, are cumulated starting from the first date of the time interval 230, which is date 1 in this example. The time may be measured in any suitable measure, like for example any discrete dates or time periods. In one implementation, the time may be measured in buckets for example. The capacity demand 220 is formed by sales orders 221, 222, 223 of different requested amounts (amounts are indicated by height of sales order in a not to scale manner) on different requested dates. The amounts may be converted into hours of capacity or vice versa. As long as the capacity demand 220 is not greater than the capacity supply, there is no overconfirmation situation present.

A ware demand, like a sales order, may have different operations (activities) needed to produce the ware. These different operations may have to be carried out using different resources, or even at different work centers. Therefore, not only one resource may be associated with a ware, but at least one other resource may also be associated therewith.

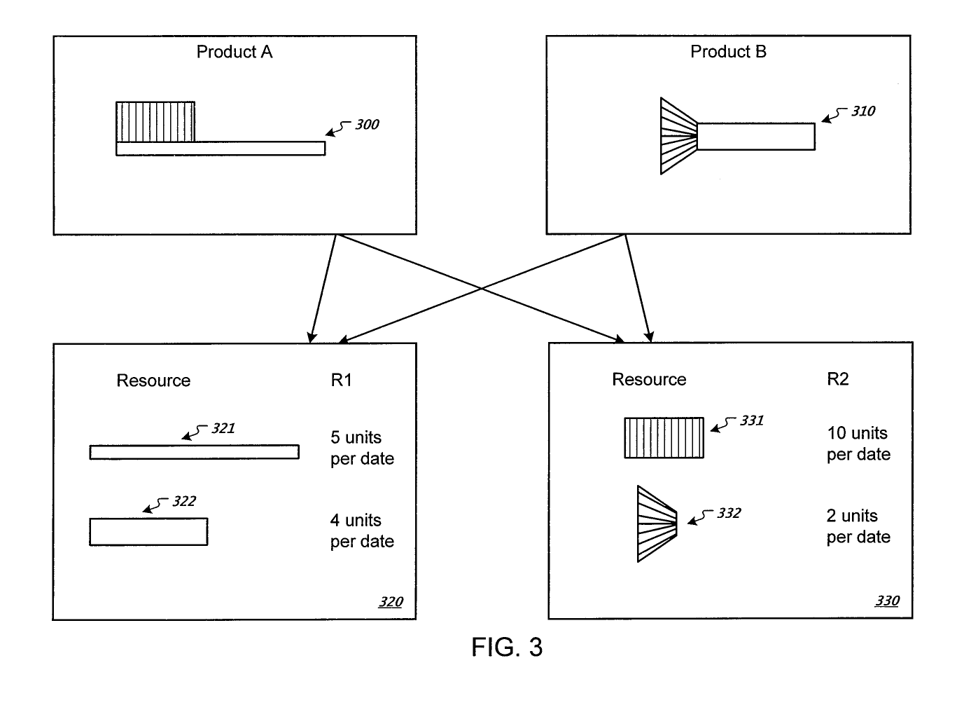

FIG. 3 shows an exemplary production of two wares using each two resources. In this example, for producing product A 300, for example a toothbrush, a first part 321 and a second part 322 is needed. First part 321 of product A is produced by resource R1, being able to produce 5 units of the first part 321 per date which is the capacity constraint of resource R1 for product A. Second part 322 of product A is produced by resource R2, being able to produce 10 units of the second part 322 per date which is the capacity constraint of resource R2 for product A. For product A, resource R1 may for example be determined as being a bottleneck resource. In some implementations, a resource may be considered a bottleneck resource if its capacity constraints are such that they directly affect the ability to effectively produce the ware; that is, the bottleneck resource can be viewed as holding up the production of the ware at one or more stages. Similarly, for producing product B 310, for example another type of brush, a first part 331 and a second part 332 is needed. First part 331 of product B is produced by resource R1, being able to produce 8 units of the first parts 331 per date which is the capacity constraint of resource R1 for product B. Second part 332 of product B is produced by resource R2, being able to produce 3 units of the second parts 332 per date which is the capacity constraint of resource R2 for product B. For product B, resource R2 may for example be determined as being the bottleneck resource. Accordingly, a resource may be used to produce not only one single ware, but may be used to produce at least one other ware.

In a computer-implemented method for checking availability of a set of wares in a time interval, each ware has associated therewith at least one resource to produce the ware. When determining availability for a specific resource, the first step of such a method can be to determine the wares associated with the specific resource. Availability information for each of the determined wares may then be obtained. When a demand comes in, for example a sales order from a customer requesting a specific ware, the availability of the specific ware for the specific resource may then be determined using the obtained availability information.

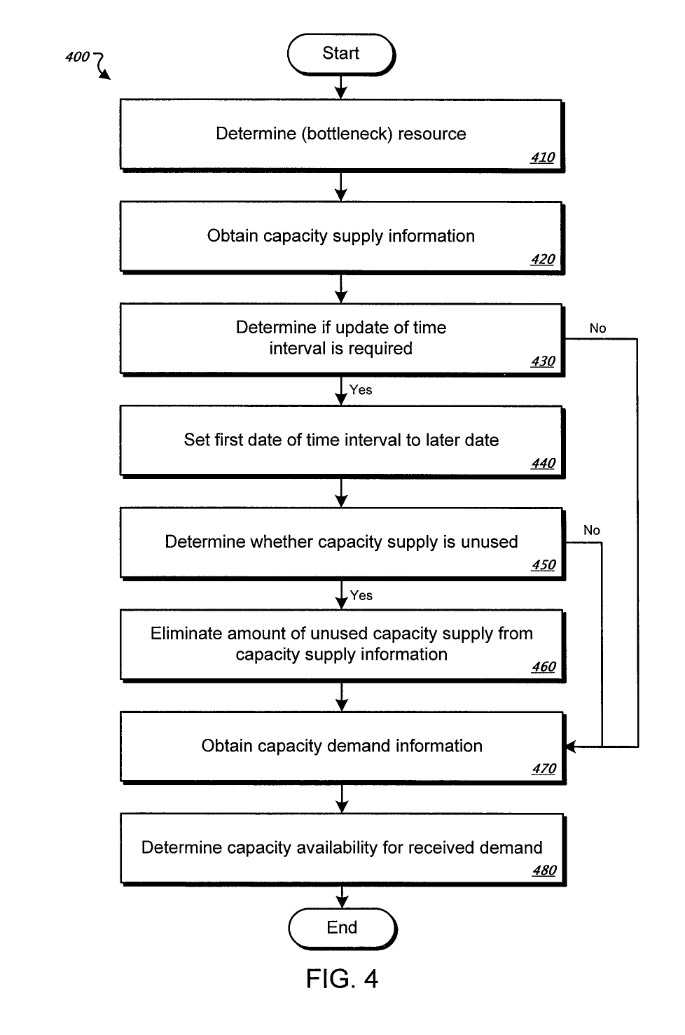

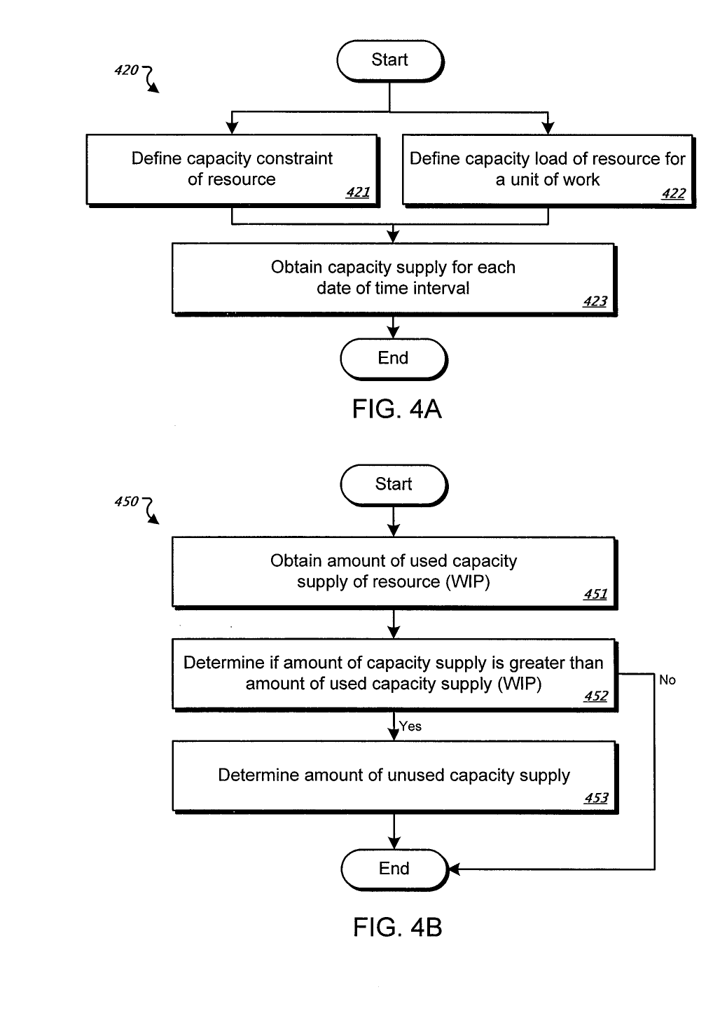

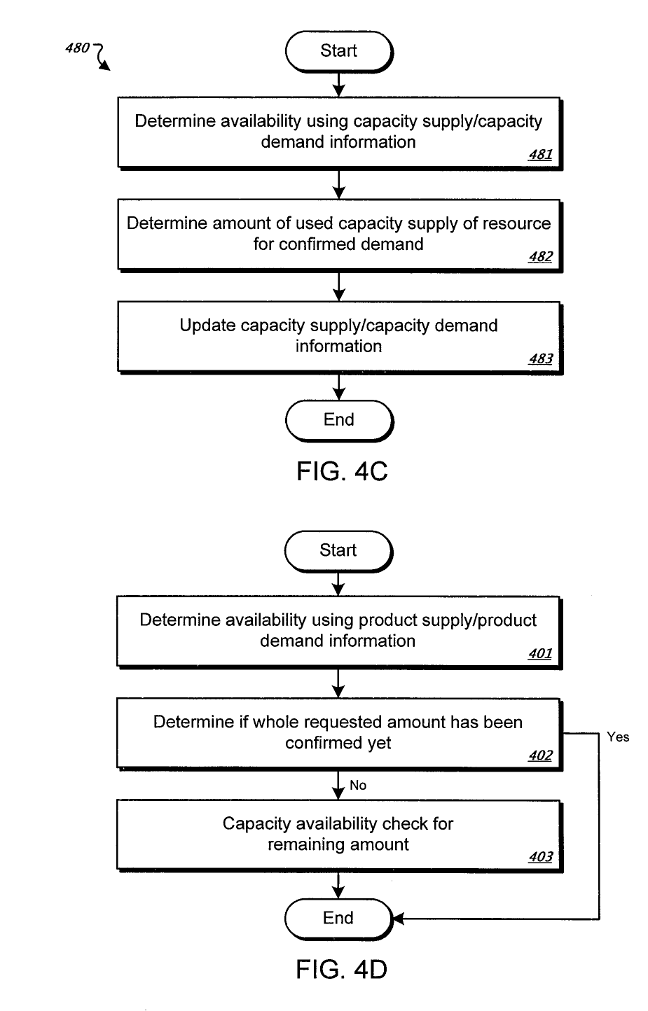

Determining availability of a specific ware may be done in many different ways. FIG. 4 is a flowchart showing a computer-implemented method for checking the availability of a ware in a time interval which may be used in connection with a computer-implemented method for checking availability of a set of wares in a time interval. In step 410, a resource to produce the ware may be determined, the resource therefore being associated with the ware. In general, the resource can be any resource used to produce the ware. In one implementation, the resource may be a bottleneck resource for producing the ware as explained with reference to FIG. 3. In other implementations, multiple bottleneck resources may be determined.

Next, in step 420, capacity supply information is obtained, comprising a capacity supply for each date of the time interval. The capacity supply may be cumulated starting from the first date of the time interval as explained with reference to FIG. 2.

FIG. 4A shows an exemplary implementation of obtaining capacity supply information in step 420. In this example, a capacity constraint of the resource is defined in step 421. This may for example be x units per date, meaning that the resource has capacity to produce x units of the ware on a specific date. The capacity constraint may also vary depending on the date. For example, time-dependent limit values may be defined for the constraint. Additionally, in step 422, a capacity load of the resource for a unit of the ware may be defined. This may for example be y hours per unit meaning that the resource capacity is needed for y hours in order to produce one unit of the ware. The capacity load could be any suitable measure, like for example a weighing figure (e.g. capacity load for product A is z times an average value). In step 423, the capacity supply may then be obtained for each date of the time interval, thereby forming capacity supply information. In the example mentioned above, a capacity constraint of x units of ware and a capacity load of y hours per unit of ware would result in a capacity supply of x times y hours.

When using a supply chain management system, time proceeds and past supply and demand data may have to be updated. For product availability check, past product supply generally remains on stock. For capacity availability check however, past capacity supply may not be stored as time proceeds and is thus lost. Therefore, it has to be determined whether capacity supply has been lost or not.

In step 430 it is determined whether an update of the time interval is required, perhaps since time has proceeded. This may be the case when a corresponding update information is received indicating that the first date of the time interval has been set to a later date (for example shifting periods towards the future when the first period has passed). If an update is not required, the method proceeds to step 470. If an update is required, however, the first date of the time interval is set to the later date in step 440. Subsequently, in step 450, it is then determined whether capacity supply is unused for each date from the first date to the last date. In one implementation, the later date may be the date after the first date. In such a case, the determination of unused capacity supply needs only be carried out for one date.

FIG. 4B shows an exemplary implementation of determining whether capacity supply is unused in step 450. In step 451 an amount of used capacity supply of the resource on that date is obtained. This may also be associated with work-in-process (WIP), an amount of production of a product for example. Subsequently, in step 452 it is determined if the amount of capacity supply on that date is greater than the amount of used capacity supply on that date. If this is the case, a certain amount of capacity supply has not been used to produce ware on that date and is therefore lost. In step 453, the amount of unused capacity supply is determined, for example by taking the difference between the amount of capacity supply and the amount of used capacity supply. As long as the capacity supply does not exceed the amount of used capacity supply (WIP), it is assumed that it has been used to produce that amount of the product.

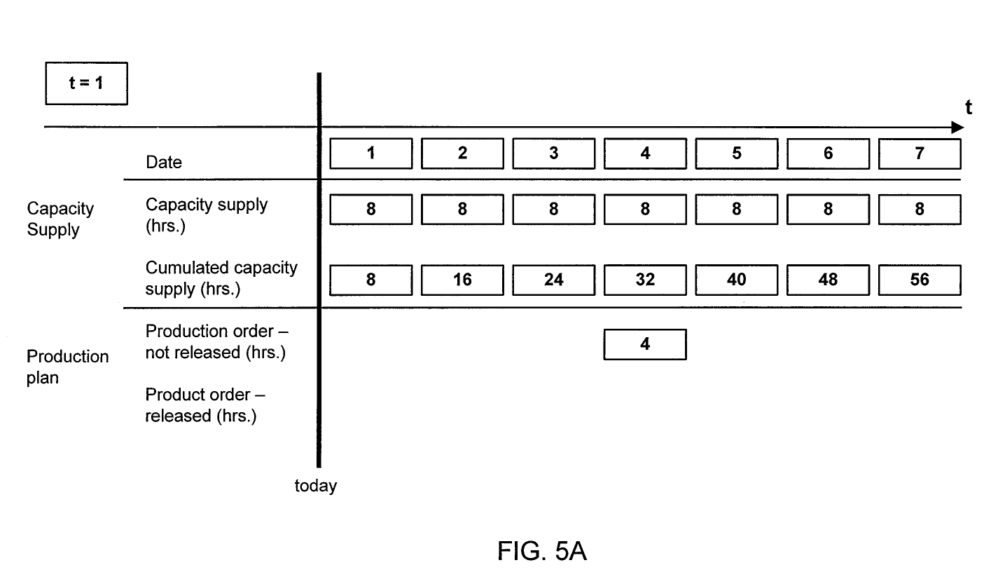

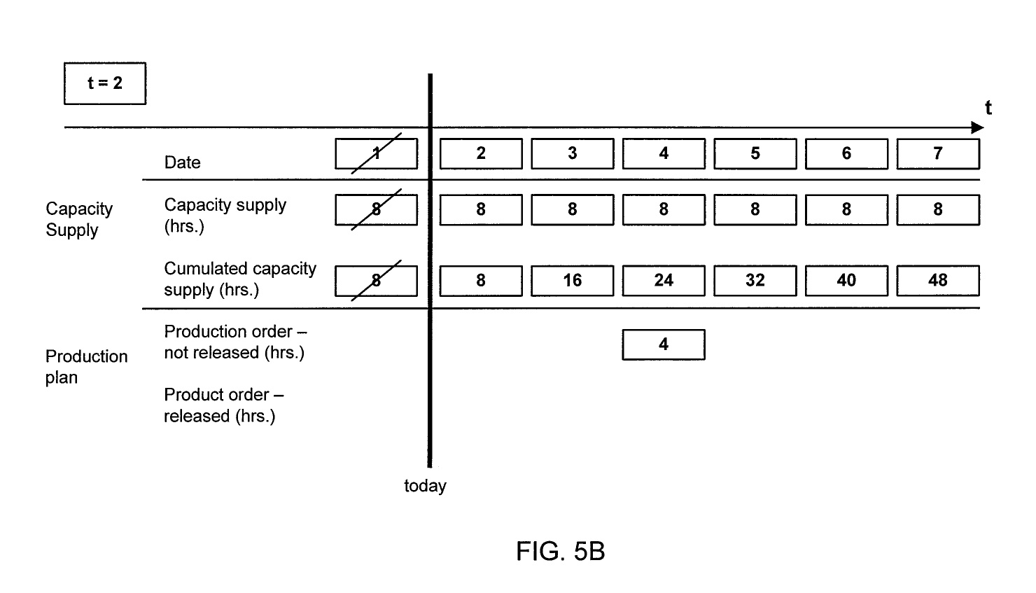

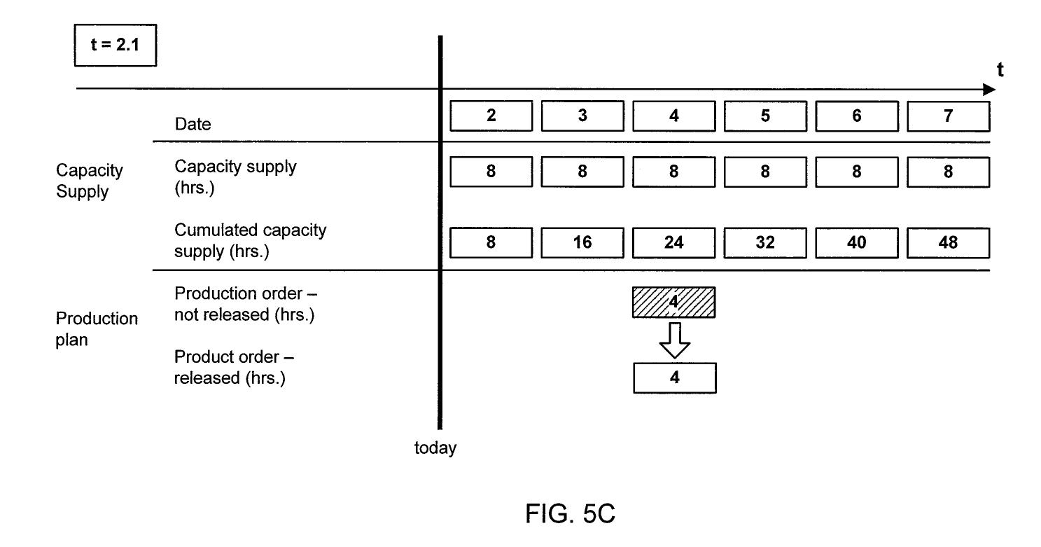

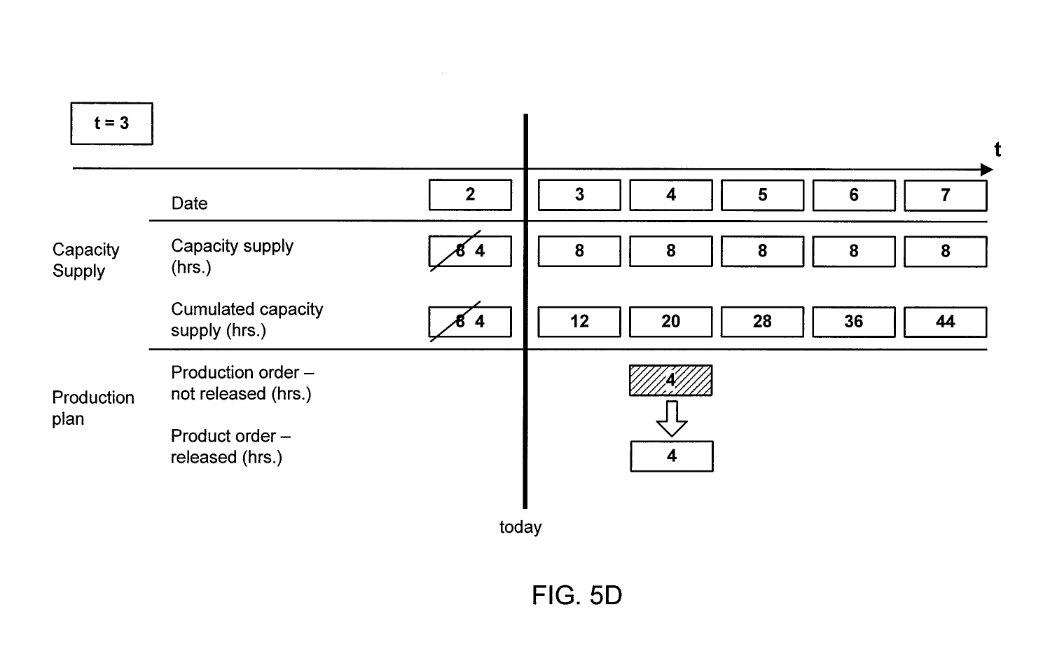

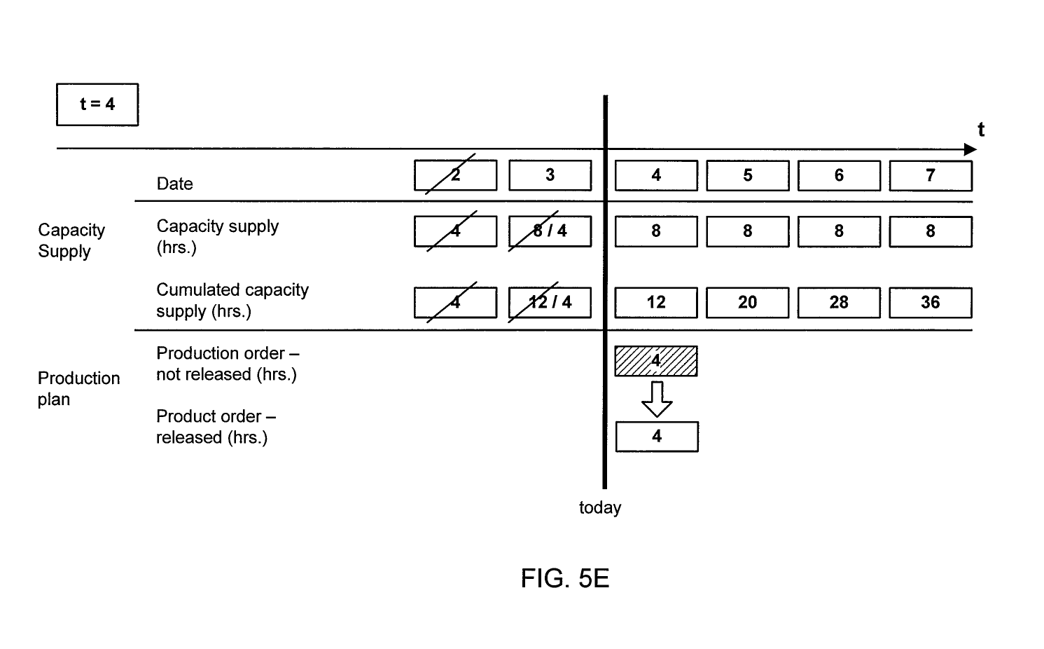

Returning to FIG. 4, when an amount of unused capacity supply has been determined, that amount is then eliminated from the capacity supply information. When capacity is lost today, it cannot be used on subsequent days in the future anymore. The amount of unused capacity may for example be eliminated from the cumulated capacity supply. The amount of used capacity is not eliminated from the capacity supply information since it is assumed that it has been used to produce the product. Examples of eliminating unused capacity supply will be described in more detail with reference to FIG. 5A-5E.

The method may then proceed to step 470 of obtaining capacity demand information. This may be the case when a demand information is received representing a demand having a requested date. The capacity demand information for the resource may then be obtained. This capacity demand information may also be obtained at an earlier point of time. However, a received demand information may need to be updated. The capacity demand information comprises capacity demand for each date of the time interval and may be cumulated starting from the first date of the time interval as explained with reference to FIG. 2.

In step 480 a capacity availability check for the received demand is performed. This can be done in any suitable manner. For example, this can be done by performing a collective availability check for a set of demands. The capacity availability check (CAC) may be performed similarly to the product availability check (PAC).

FIG. 4C shows an exemplary implementation of performing the capacity availability check in step 480. The implementation of FIG. 4C may for example be used in a pure make-to-stock environment where there is no supply on stock. The availability for a received demand can in such implementations thus be based only on using the capacity supply and capacity demand information (step 481). When there is no overconfirmation present, the received demand may be confirmed. In step 482, the amount of capacity supply of the resource used by the confirmed demand is then determined, which is the amount of used capacity as explained above. Subsequently, in step 483 the capacity demand and capacity supply information may be updated accordingly.

In environments where there is at least some product supply in stock, a product availability check may be used before performing a capacity availability check, as indicated in FIG. 4D. The availability for a specific demand may then first be based on checking the product availability. Therefore, in step 401 the availability is determined by product availability check, using product supply information and product demand information. This information may also be provided in the form of time series, for example cumulated starting from the first date of the time interval. In step 402 it is then determined if the whole requested amount of the received demand has been confirmed based on the product availability check. If this is not the case, in step 403, the remaining amount of the received demand may be determined by capacity availability check as described above. In such a case, the capacity demand and capacity supply information as well as the product supply and product demand information may be updated accordingly.

The capacity supply and capacity demand information may be updated synchronously with the product supply and product demand information, for example when a production order is created or released. The capacity supply and capacity demand information may also be updated asynchronously with the product supply and product demand information, for example only when an availability check is performed.

The method described above may also be used as capacity check when creating or releasing production orders (production plan). FIG. 5A-5E are diagrams showing an example execution of a method as described above for checking the availability of a ware in a time interval using a production plan. FIG. 5A shows for each date, or bucket, of the time interval ranging from date 1 through date 7 the capacity supply of the resource for a given product and its production plan. The amount of capacity supply as well as the production orders are expressed in terms of capacity units (hours the resource is used). In FIG. 5A, the capacity supply of the resource indicates that on each date the resource is available for 8 hours to produce the given product. The cumulated capacity supply is the sum of the capacity supply cumulated starting form the first date. In FIG. 5A, after having received a demand having a requested date, a production order of amount 4 (4 hours) is scheduled for requested date 4 (planned production order), but is not being released yet. As time proceeds, turning now to FIG. 5B, the capacity supply on date 1 becomes past supply because the today line has moved forward. Because no production order has been released yet, there is no used capacity supply of the resource on that date. The amount of 8 hours of capacity supply on date 1 has not been used and therefore needs to be eliminated from the capacity supply information, indicated by the diagonal line crossing out the amount. The cumulated capacity supply for dates 2 to 7 changes accordingly. FIG. 5C shows a point of time when the production order is released. At this point of time the demand having requested date 4 is not confirmed based on capacity anymore, but changes to being confirmed based on available product.

FIG. 5D shows another progression of time, when the today line has moved forward and capacity supply on date 2 becomes past capacity supply. Since a production order of amount 4 has now been released, an optimistic assumption is made that 4 hours of capacity supply on date 2 were not lost, but rather were used for the released production order to produce the product. Therefore, the amount of used capacity supply (WIP) on date 2 is 4. The amount of unused capacity on date 2 is thus 4, which is eliminated from the capacity supply information as indicated by the diagonal line crossing out the amount. The amount of used capacity of 4 is not eliminated since it has, according to the optimistic assumption, been used to produce the product. The cumulated capacity supply for dates 3 to 7 changes accordingly. In FIG. 5E the today line has moved forward to date 4 and the capacity supply on date 3 becomes past supply. Since the production order on requested date 4 is still set as released and a production confirmation has not been received yet, again the amount of used capacity of 4 is eliminated from the capacity supply. As time proceeds further, a production confirmation is expected to be received, in the best case confirming the optimistic assumption that 4 hours of capacity supply have been used to produce ware.

When a production order is released, the amount of capacity supply needs to be used product specific. Therefore, this amount of used capacity supply is no longer available for any other demands. When the production is anonymous, it is not known which demand is being produced by that amount of used capacity supply. Accordingly, the capacity demand cannot be reduced since it is not demand specific. If the capacity demand cannot be decreased, the capacity supply also cannot be decreased at that point of time.

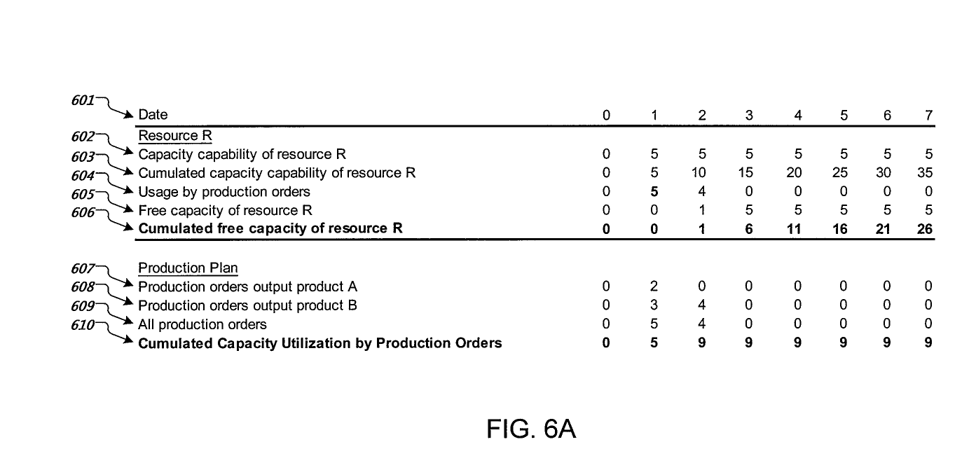

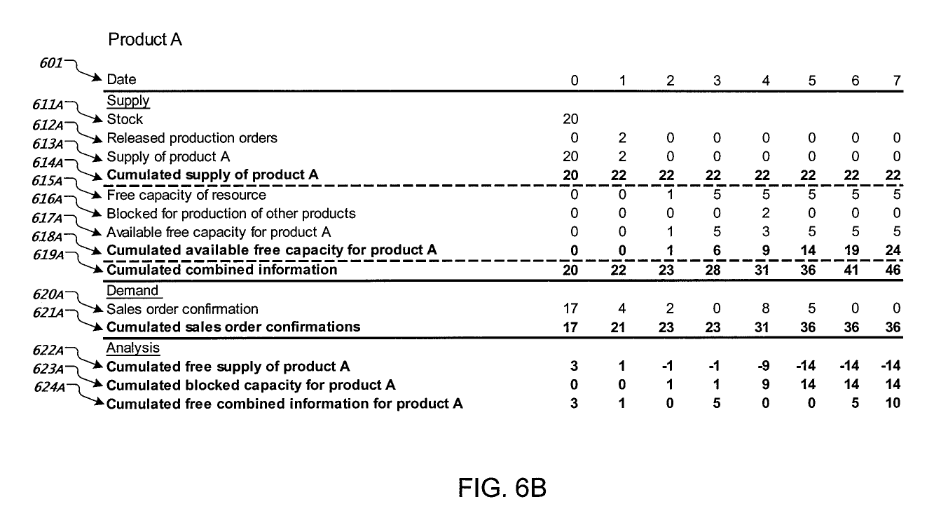

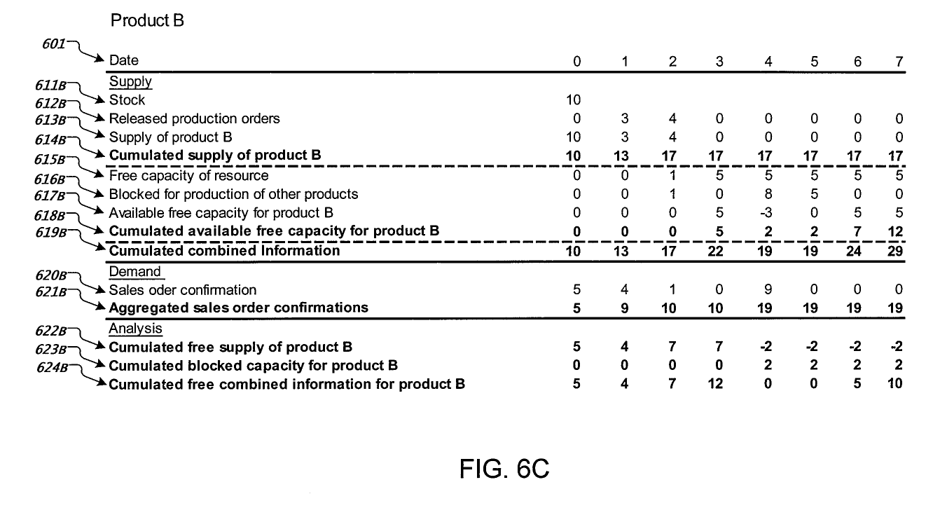

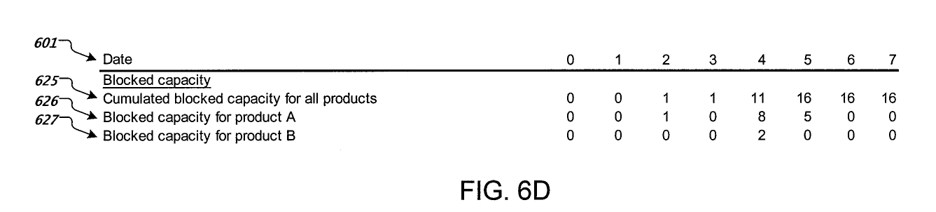

The description now turns to a computer-implemented method for checking availability of a set of wares in a time interval, each ware having associated therewith at least one resource to produce the ware. FIG. 6A-6D are tables used for an example computer-implemented method for checking availability of a set of products in a time interval. When determining availability for a specific resource R, the capacity capability 602 of the resource, which may also be referred to as capacity constraint of the resource R, may be obtained for each date 601 of the time interval, as can be seen in FIG. 6A. The capacity capability 602 may then be cumulated starting from the first date of the time interval, resulting in a cumulated capacity capability 603 of the resource R.

When determining availability for the specific resource R, the first step of such a method would be determining the products associated with the specific resource R. In the example of FIG. 6A-6D, at least product A and product B are each associated with resource R.

When there is a production plan, information regarding released production orders for product A and product B may be obtained for each date 601 of the time interval, illustrated by reference numerals 607 and 608 in FIG. 6A respectively. This information may be added together to form information regarding all production orders 609 (corresponding to 604) for resource R and may then be cumulated starting from the first date of the time interval, yielding a cumulated capacity utilization of resource R by all production orders (reference numeral 610).

The specific resource may have free capacity, also referred to as generic capacity, which can be assigned to any one of the determined products. This means that this free capacity of the resource will then be used to produce that product, in this example product A or product B. Once a certain amount of free capacity has been assigned to a product, it is blocked for that product and cannot be used anymore by other products associated with the resource.

In FIG. 6A, the free capacity 605 of the resource R is obtained by subtracting, for each date, the usage by all production orders 604 from the resource capability 602 of the resource. Correspondingly, the cumulated free capacity 606, cumulated starting from the first date of the time interval, may be obtained. The cumulated free capacity 606 may also be obtained by subtracting the cumulated capacity utilization by production orders 610 from the cumulated capacity capability 603 of the resource.

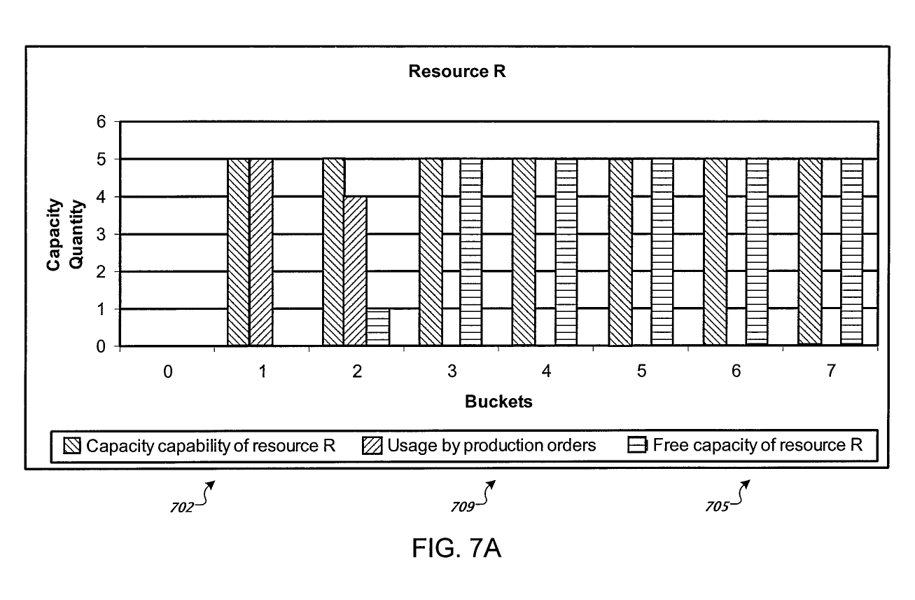

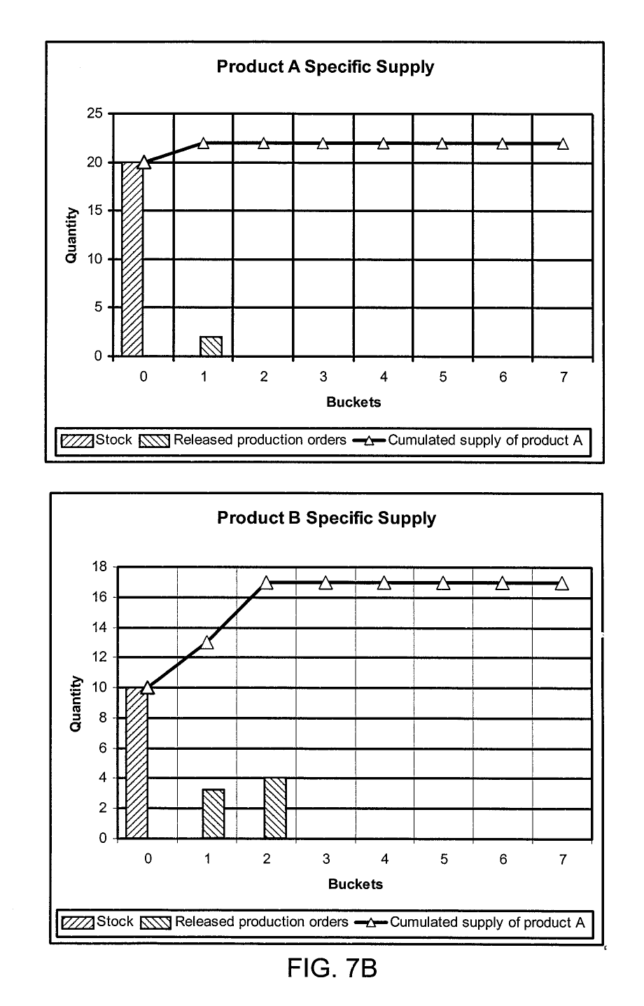

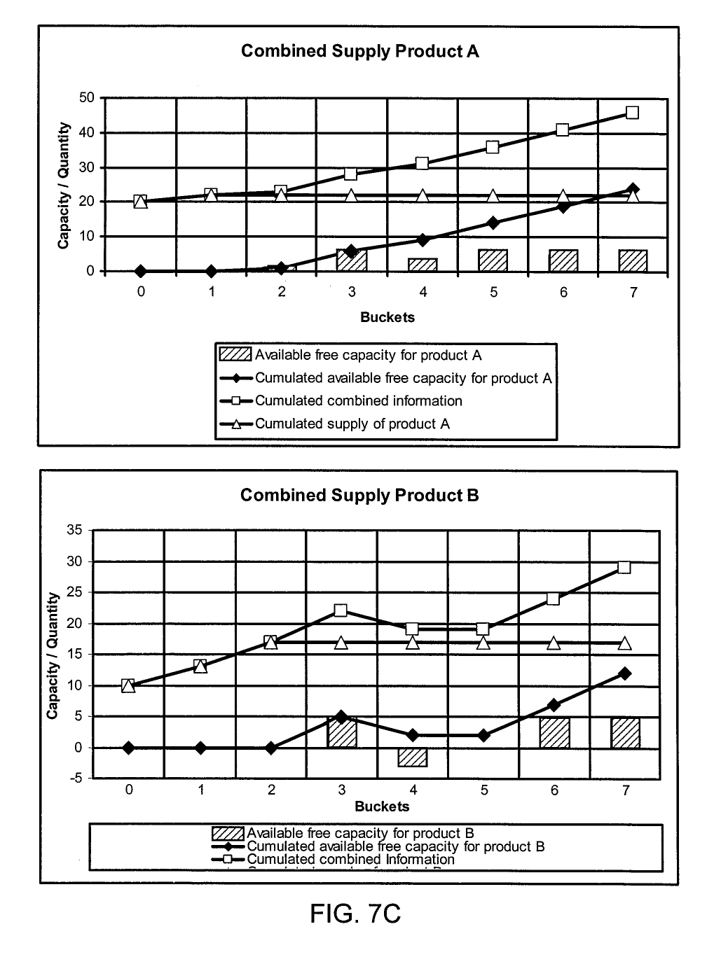

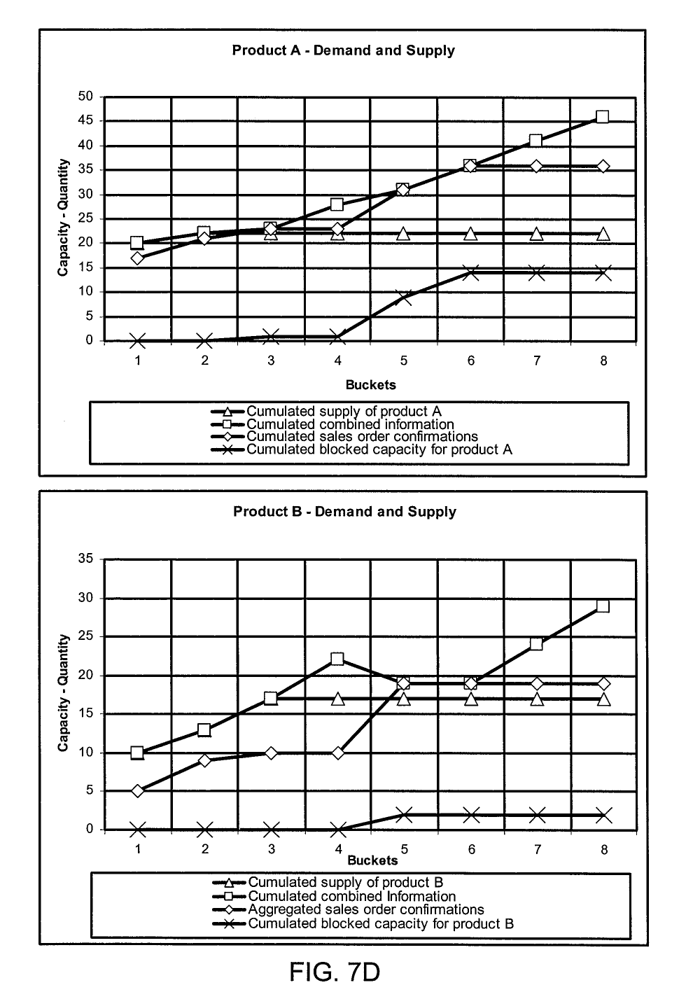

FIG. 7A shows a diagram of the capacity capability 702 of the resource R, the usage by all production orders 709 and the free capacity 705 of the resource R for each date of the time interval, ranging from date 0, indicating today for example, through date 7.

In a further step, availability information for each of the determined products A and B may be obtained. FIG. 6A and FIG. 6B show availability information for product A and product B, respectively.

When a demand is received, for example a sales order from a customer requesting one of the products A and B, the availability of the specific product for the resource R may then be determined using the availability information. It may be determined based on available supply of the product and based on available capacity of the resource for that product. By using both information simultaneously, an optimal confirmation may be issued. It allows for the fact that flexible resources can also be used to produce and procure the product.

When combining supply quantity of a product and capacity quantity of the resource, a common quantity measure must be found.

In one implementation, the supply quantity of the ware may be expressed in terms of capacity units needed to produce that supply quantity using the specific resource (for example hours of the resource). For example, for a resource being able to produce 10 units of the product per hour (capacity constraint), a supply quantity of 20 units may correspond to a capacity of 2 hours.

In another implementation, a capacity quantity can likewise be expressed in terms of supply or product units resulting when using that capacity supply of the resource, for example when several products are measured in the same units. However, for the following examples given in the description, supply quantity will be expressed in terms of capacity units.

In a similar manner, when determining the availability of a product by using a demand quantity and a supply quantity, a common quantity measure must be found.

Also in this case, the demand quantity and the supply quantity can be expressed in terms of capacity units in one implementation. In another implementation, the demand quantity and the supply quantity can be expressed in terms of supply or product units.

Now the description will focus on the availability information for product A. The following description given with respect to FIG. 6B for product A also applies in an analogous way to FIG. 6C for product B.

In FIG. 6B supply information 611A-619A is shown. On the one hand, the supply information comprises a supply quantity 613A of product A for each date 601 of the time interval. Analogously, FIG. 6C contains reference numbers corresponding to those used in FIG. 6B. For example, in FIG. 6C the supply information comprises a supply quantity 613B of product B for each date 601 of the time interval, and so on. The supply quantity 613A may be obtained by stock 611A on date 0, for example today, and the released production orders 612A for product A on all future dates 1 to 7 of the time interval. Accordingly, a cumulated supply quantity 614A of product A, cumulated starting from the first date of the time interval, may be obtained. On the other hand, the supply information comprises a free capacity quantity 617A for product A for each date 601 of the time interval. The free capacity quantity may be obtained by subtracting a blocked capacity quantity 616A, that is assigned to another product other than product A, from the free capacity 615A of the resource (reference numeral 605 of FIG. 6A). Accordingly, a cumulated free capacity quantity 618A for product A, cumulated starting from the first date of the time interval, may be obtained.

In order to use both information simultaneously, the supply quantity of product A as well as the free capacity quantity of the resource for product A, a combined information may be obtained. Cumulated combined supply information 619A represents, for each date 601 of the time interval, the sum of the cumulated supply quantity 614A of product A and the cumulated free capacity quantity 618A for product A. The combined information may also not only be obtained on a cumulated basis, but may be given for each date individually.

FIG. 7B shows the product specific supply for product A and B, respectively. The cumulated supply quantity is obtained by taking the stock on date 0 and the released production orders for the product on all future dates 1 to 7 of the time interval and cumulating the values starting from the first date 0 of the time interval.

FIG. 7C shows the combined supply for product A and B, respectively. The cumulated supply information of product A is obtained by adding, for each date of the time interval, the cumulated available free capacity for product A and the cumulated supply quantity of the product.

In order to perform a availability check, not only supply information 611A-619A may be needed, but also product demand information 620A-621A. In this example, the demand is received in form of sales orders placed by customers. In FIG. 6B, for each date 601 of the time interval, sales orders which have already been confirmed to a customer are shown as sales order confirmations 620A. Again, the cumulated sales order confirmations 621A are cumulated starting from the first date of the time interval.

In order to determine the availability of the product A, further analysis information 622A to 624A may be needed. A cumulated free supply of product A may be obtained by subtracting the cumulated sales order confirmations 621A from the cumulated supply 614A. The free supply represents the supply quantities of product A that are available and have not been used yet, for example promised to a customer in form of a sales order. In FIG. 6B, on date 0 for example, a free supply quantity of 3 is still available. However, on date 4 for example, no free supply quantity is available anymore, but a quantity of 9 needs to be produced by using free capacity of the resource, indicated by the number −9. Accordingly, the cumulated blocked capacity for product A 623A is the negative sign of the cumulated free supply 622A, given that this value is negative. In other words, the cumulated blocked capacity for product A is the maximum of zero and the negative value of the cumulated free supply 622A. Also a cumulated free combined information 624A may be obtained by subtracting the cumulated sales order confirmations 621A from the cumulated combined supply 619A.

The blocked capacity for product A may also not only be obtained on a cumulated basis, but may be given for each date individually. In FIG. 6D, the blocked capacity for product A 626 as well as for product B is given. Accordingly, a cumulated blocked capacity for all products 625 may be obtained.

Upon receiving an information representing for example a sales order requesting either product A or product B, the information shown in FIG. 7D may be used in order to determine availability of a the respective product A or B. When product A is requested, the information given in the left hand diagram may be used, whereas, when product B is requested, the information in the right hand diagram may be used. FIG. 7D shows, for each of the products A and B, the cumulated supply quantity of the product (corresponding to reference numerals 614A and 614B in FIG. 6B and FIG. 6C respectively) as well as the cumulated combined supply information (corresponding to reference numerals 619A and 619B in FIG. 6B and FIG. 6C respectively). Furthermore, FIG. 7D shows, for each of the products A and B, cumulated sales order confirmations (corresponding to reference numerals 621A and 621B in FIG. 6B and FIG. 6C respectively), representing a product demand, or generally referred to as ware demand. Therefore, for each date of the time interval, a demand quantity of the product is given.

The product demand may be compared to the combined supply information. For a specific date, a ware demand, like a sales order, may be confirmed as long as the cumulated sales order confirmation does not exceed the cumulated combined supply information. In a case where the cumulated sales order confirmations are equal or smaller than the cumulated supply quantity of the product (the demand quantity being equal or smaller than the supply quantity), the product can be based on product supply only and no additional capacity needs to be blocked. As can be seen in the left hand diagram, for product A this is the case for example on date 0 and 1. In such a case the availability information, in particular the combined supply information, for the corresponding product, in this example product A, may be updated.

However, in a case where the cumulated sales order confirmations exceed the cumulated supply quantity of the product (the demand quantity being greater than the supply quantity), the availability of the product can not only be based on product supply but also additional capacity needs to be blocked. As can be seen in the left hand diagram, for product A this is the case for example on date 4 and 5. On date 4 a capacity quantity of 8 and on date 5 a capacity quantity of 5 needs to be blocked for the production of product A. In such a case not only the availability information, in particular the combined supply information, for the corresponding product, in this example product A, needs to be updated, but also the availability information of all other products associated with the resource need to be updated, like the availability information of product B in this example.

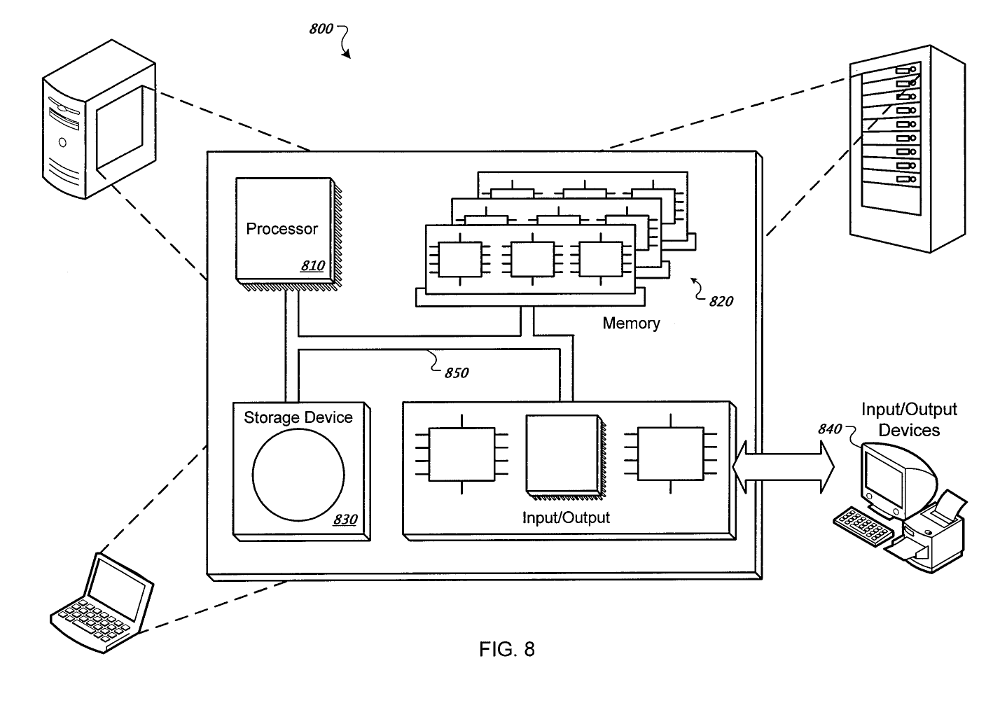

FIG. 8 is a schematic diagram of a generic computer system 800. The system 800 can be used for the operations described in association with any of the computer-implemented methods described previously, according to one implementation. The system 800 includes a processor 810, a memory 820, a storage device 830, and an input/output device 840. Each of the components 810, 820, 830, and 840 are interconnected using a system bus 850. The processor 810 is capable of processing instructions for execution within the system 800. In one implementation, the processor 810 is a single-threaded processor. In another implementation, the processor 810 is a multi-threaded processor. The processor 810 is capable of processing instructions stored in the memory 820 or on the storage device 830 to display graphical information for a user interface on the input/output device 840.

The memory 820 stores information within the system 800. In one implementation, the memory 820 is a computer-readable medium. In one implementation, the memory 820 is a volatile memory unit. In another implementation, the memory 820 is a non-volatile memory unit.

The storage device 830 is capable of providing mass storage for the system 800. In one implementation, the storage device 830 is a computer-readable medium. In various different implementations, the storage device 830 may be a floppy disk device, a hard disk device, an optical disk device, or a tape device.

The input/output device 840 provides input/output operations for the system 800. In one implementation, the input/output device 840 includes a keyboard and/or pointing device. In another implementation, the input/output device 840 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device or in a propagated signal, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of embodiments of the invention have been described. Nevertheless, it will be understood that various modifications may be made without departing from the spirit and scope of the invention. Accordingly, other embodiments are within the scope of the following claims.

What is claimed is:

1. A computer-implemented method for checking availability of a set of wares in a time interval, each ware having associated therewith at least one resource to produce the ware, the method comprising, for a specific resource:
determining at least first and second wares associated with the specific resource;
obtaining availability information for each of the determined first and second wares, the availability information comprising:
combined information comprising, for each date of the time interval, a combination of (i) a supply quantity of the ware and (ii) a free capacity quantity of the specific resource that can be assigned to any of the determined first and second wares, and
in response to receiving a demand information representing a demand for a specific ware, determining the availability of the specific ware for the specific resource using at least the combined information.

2. The computer-implemented method of claim 1, wherein the supply quantity and the free capacity quantity is each cumulated starting from a first date of the time interval.

3. The computer-implemented method of claim 1, wherein the supply quantity of the ware is expressed in terms of capacity units needed to produce said supply quantity using the specific resource.

4. The computer-implemented method of claim 1, wherein the combination includes a sum of the supply quantity of the ware and the free capacity quantity of the specific resource.

5. The computer-implemented method of claim 1, wherein the availability information further comprises blocked capacity information indicating for each date of the time interval a blocked capacity quantity, which is assigned to a corresponding one of the first and second wares, of the specific resource.

6. The computer-implemented method of claim 5, wherein associated with each blocked capacity quantity, which is assigned to the corresponding ware, is a production order.

7. The computer-implemented method of claim 6, wherein the supply quantity of the corresponding ware comprises a stock of the corresponding ware and production orders associated with the corresponding ware.

8. The computer-implemented method of claim 6, wherein the free capacity quantity is derived from a capacity capability of the specific resource and a blocked capacity quantity of the resource that is assigned to another ware other than the corresponding ware.

9. The computer-implemented method of claim 1, wherein the availability information further comprises ware demand information comprising, for each date of the time interval, a demand quantity of the ware, the demand quantity being compared to at least the combined information when determining the availability of the specific ware.

10. The computer-implemented method of claim 9, wherein, after determining the availability of the specific ware for the specific resource, provided that the demand quantity is equal or smaller than the supply quantity, the combined information of the specific ware is updated.

11. The computer-implemented method of claim 9, wherein, after determining the availability of the specific ware for the specific resource, provided that the demand quantity is greater than the supply quantity, the combined information of all wares associated with the resource is updated.

12. The computer-implemented method of claim 1, wherein the specific resource is a bottleneck resource.

13. A computer program product tangibly embodied in a computer-readable storage medium and comprising executable instructions that, when executed, perform operations for checking availability of a set of wares in a time interval, each ware having associated therewith at least one resource to produce the ware, the operations comprising, for a specific resource:
determining at least first and second wares associated with the specific resource;
obtaining availability information for each of the determined first and second wares, the availability information comprising:
combined information comprising, for each date of the time interval, a combination of (i) a supply quantity of the ware and (ii) a free capacity quantity of the specific resource that can be assigned to any of the determined first and second wares, and
in response to receiving a demand information representing a demand for a specific ware, determining the availability of the specific ware for the specific resource using at least the combined information.

14. The computer program product of claim 13, wherein the supply quantity and the free capacity quantity is each cumulated starting from a first date of the time interval.

15. The computer program product of claim 13, wherein the supply quantity of the ware is expressed in terms of capacity units needed to produce said supply quantity using the specific resource.

16. The computer program product of claim 13, wherein the combination includes a sum of the supply quantity of the ware and the free capacity quantity of the specific resource.

17. The computer program product of claim 13, wherein the free capacity quantity is derived from a capacity capability of the specific resource and a blocked capacity quantity of the resource that is assigned to another ware other than the corresponding ware.

18. The computer program product of claim 13, wherein the availability information further comprises ware demand information comprising, for each date of the time interval, a demand quantity of the ware, the demand quantity being compared to at least the combined information when determining the availability of the specific ware.

19. A computing system programmed to perform operations for checking availability of a set of wares in a time interval, each ware having associated therewith at least one resource to produce the ware, the operations comprising, for a specific resource:
determining at least first and second wares associated with the specific resource;
obtaining availability information for each of the determined first and second wares, the availability information comprising:
combined information comprising, for each date of the time interval, a combination of (i) a supply quantity of the ware and (ii) a free capacity quantity of the specific resource that can be assigned to any of the determined first and second wares, and
in response to receiving a demand information representing a demand for a specific ware, determining the availability of the specific ware for the specific resource using at least the combined information.
